(19) United States
(12) Patent Application Publication
(10) Pub. No.: US 2013/0085897 A1
(43) Pub. Date: Apr. 4, 2013

(54) GEOCENTRIC CONSUMER AND ORGANIZATION NETWORK

(71) Applicant: Michele L. Favoretto, Madison Heights, MI (US)

(72) Inventor: Michele L. Favoretto, Madison Heights, MI (US)

(21) Appl. No.: 13/702,373

(22) PCT Filed: Feb. 20, 2012
(86) PCT No.: PCT/US12/25780

§ 371 Date: Dec. 6, 2012

Related U.S. Application Data
(60) Provisional application No. 61/444,377, filed on Feb. 18, 2011.

(51) Int. Cl. G06Q 30/00; G06F 17/30

(52) U.S. Cl. CPC G06Q 30/0641; G06F 17/30595
USPC 705/27.1; 707/825

(57) ABSTRACT

A disclosed system and method provides for users to purchase and take temporary virtual ownership of any select inch of the earth or ocean. This selection provides the user with unique ownership of the mapped coordinates. To secure virtual ownership of their selected inch, each user pays a small fee, paid and renewed annually. They then select a preferred or featured organization to receive a portion of the fee. The owner is presented with a printable certificate for their virtual inch of the earth/ocean to authenticate their purchase. Their inch is then plotted on a virtual map where they can add personal stories or memorial comments, pictures, and link videos that describe why that inch is significant to them. Users can then invite family and others with common interest to purchase the neighboring inches.

### CROSS REFERENCE TO RELATED APPLICATION

This application claims priority to U.S. Provisional Application No. 61/444,377 that was filed on Feb. 18, 2011.

### BACKGROUND

This disclosure generally relates to a method and system executed as a web and/or mobile application for associating coordinates indicative of geographic location with an organization and a user. More specifically, the disclosed method and system provides a network for generating revenues for organizations by collecting fees from users based on selected coordinates indicative of a geographic location associated with one of many selected organizations.

Networking applications accessible through internet access devices are popular and becoming increasingly used for generating revenue and interest in commercial enterprises. Advertising, and direct marketing applications use location based network capabilities to direct interest and marketing based on location information communicated through mobile devices. Such systems utilize information provided by a user to link companies and organizations based on determined interests and market studies. Such systems utilize the actual location or communicated location of the user. Moreover, such networking systems are mostly directed toward linking people of like interests to a specific location or event.

### SUMMARY

The disclosed method and system is a method and system executed as a web and mobile application that creates a geocentric social network connecting virtual ownership of coordinates representing real-world locations and social sharing of common place interests, while generating annuity based revenues for different global organizations. The different global organizations can include non-profit organizations (NPOs), non-government organizations (NGOs), businesses, Universities, National Parks, Sports Facilities or any other organization that has an interest in linking people with places and good causes. The disclosed method and system creates unique intersections of micro-spending, virtual worlds and global needs, to generate annuity based revenues from users that select locations and organizations based on their own unique interests. Moreover, the disclosed example system and method serves the unmet needs of users (personal, social, emotional and altruistic) by creating a centralized sharing network to memorialize or honor the people and places that have touched their lives, while simultaneously creating educational, analytical and micro-donation channels for many different and diverse organizations.

These and other features disclosed herein can be best understood from the following specification and drawings, the following of which is a brief description.

### BRIEF DESCRIPTION OF THE DRAWINGS

FIG. 1 is schematic illustration of an example computer system for linking users and organizations in view of a selected coordinate representing a geographic location.

FIG. 2 is a diagram illustrating example steps for linking users to a coordinate representing a geographic location and an organization.

FIG. 3 is a portion of a user interface for completing a user profile.

FIG. 4 is a portion of a user interface for selecting a coordinate representing a geographic location.

FIG. 5 is a portion of an example user interface for viewing organization information.

FIG. 6 is a portion of a user interface for completing a sign up process and obtaining a certificate indicating temporary virtual ownership.

FIG. 7 is a diagram illustrating example steps for an organization to create and maintain a profile on the example system.

FIG. 8 is a diagram illustrating an example analytical tools accessible by an organization to collect and review data relating to interactions facilitated by the example system, users and organizations.

### DETAILED DESCRIPTION

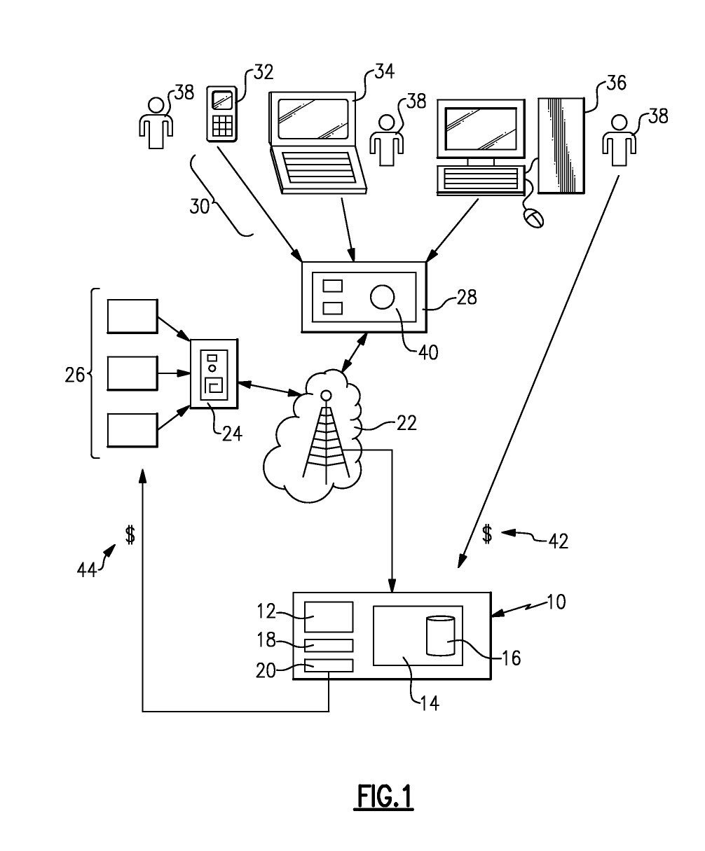

Referring to FIG. 1 an example computer system 10 for linking users, to one or more organizations based on a selected coordinate is shown and includes at least one processor 12 and at least one computer memory device 14. The disclosed system 10 generates a user accessible interface 28 accessible through an internet access device or mobile communication device as generally indicated at 30 for selecting a coordinate representing a geographic location by a user 38.

Users purchase and take temporary virtual ownership of any select inches of the earth or ocean. This selection provides the user with unique ownership of the mapped coordinates. To secure virtual ownership of their selected inch, each user pays a small fee, for example $1 a month, paid and renewed annually. They then select a preferred or featured non-profit organization to receive a portion of the fee, for example $0.75 of each dollar paid. The owner is presented with a printable “GoodDEED™” certificate for their virtual inch of the earth/ocean to authenticate their purchase. Their inch is then plotted on a virtual map where they can add personal stories or memorial comments, pictures, and link videos that describe why that inch is significant to them. Users can then invite family and others with common interest to purchase the neighboring inches or inches any place in the world. Moreover, the example system 10 is a platform which that may display many different and diverse GeoPreserves and collective organizations while portals generated through the system allow for specific promotion by organizations for their area of interest.

The example interface 28 is part of a website and/or mobile application that allows individual users 38 to select any inch of the earth or ocean and buy exclusive virtual ownership of their selected personal global coordinates. For example, a user 38 will select coordinates based on a Latitude and Longitude, for example −40.996484, −105.853271. The user 38 is then provided with a memory location 14 where they may store and share pictures, stories or link videos to describe why the selected location is important to them or a loved one and invite friends and family to select an inch nearby or anywhere in the world.

The user 38 then selects one of many organizations 26 to donate some portion 44 of an annual fee 42 charged for recording and maintaining the selected coordinate. The organizations 26 can include non-profit organizations (NPOs), non-government organizations (NGO), businesses, Universities, National Parks, Sports Facilities or any other organization that has an interest in linking people with places and good causes. In this disclosure, the term organization is utilized to reference any organization that may have an interest in linking like-minded people with each other or a specific location on the globe. The example interface 28 provides the user 38 with the ability to search and connect to locations, users and organizations of interest, create memorials, recommend causes, vote for best pictures, stories and organizations, Share ideas with NPOs, and Track global causes and keep informed of progress and needs.

Each coordinate location selected by a user 38 is saved and reserved for the individual user 38; no other users 38 may select the same location. In this example, coordinates are divided and selectable in inch increments. In other words, each inch of the earth is selectable by a user 38. The user 38 is selecting and reserving the coordinate representing that inch of the earth, not the actual physical location. The reservation of the selected coordinate selected by each user 38 is recorded in a registry 16 stored within the system 10. The specific coordinate selected by the user is recorded and reserved for the user 38 for the fee 42 for a defined time period. In this example the period is one day less than a year or 364 days. At the end of the defined period, the user 38 may pay an additional fee and maintain the exclusive virtual ownership of the selected coordinate.

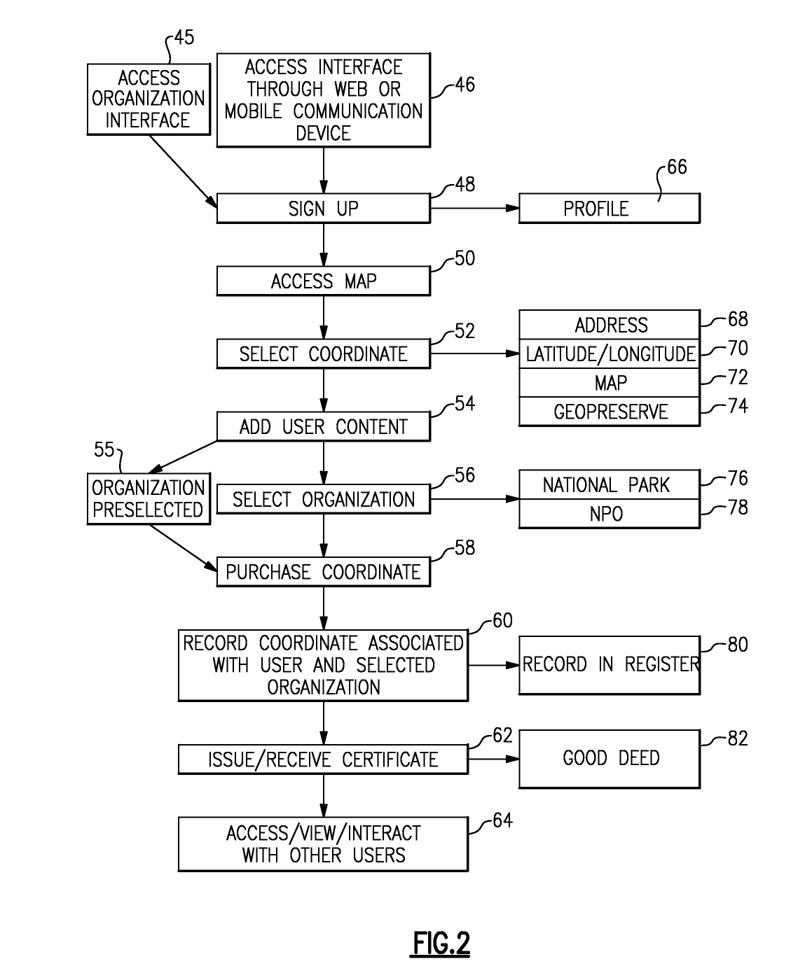

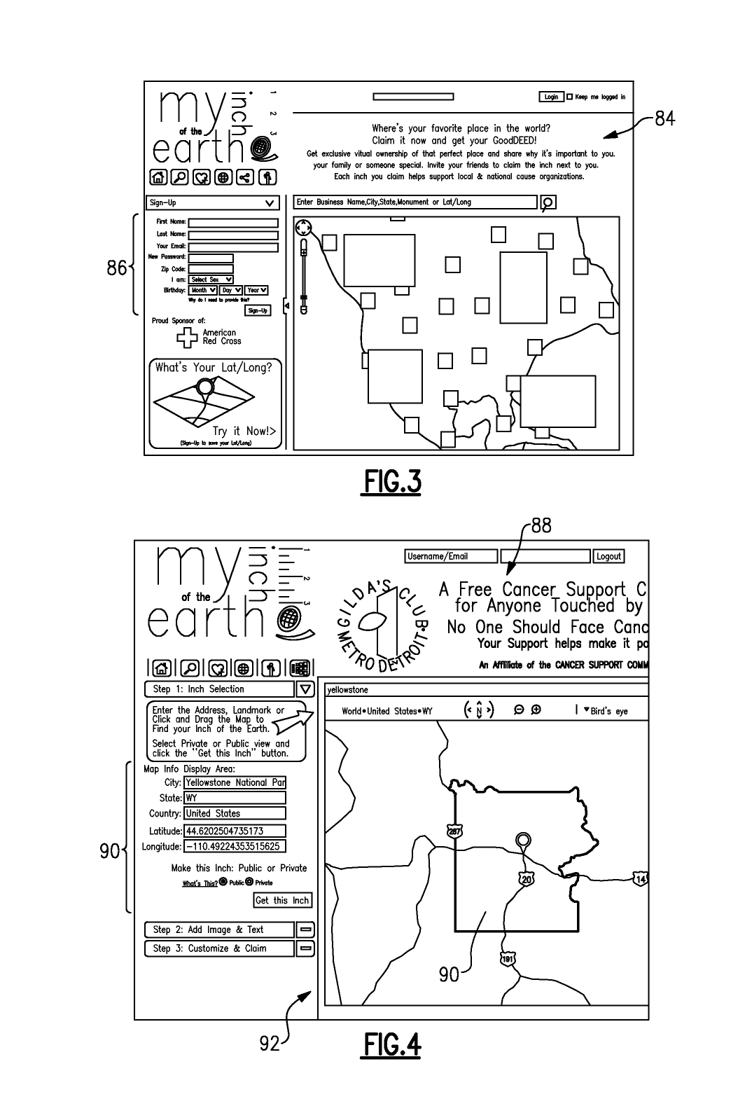

Referring to FIGS. 2 and 3, with continued reference to FIG. 1, the example system 10 provides for the interaction of a user 38 with various organizations 26 along with other users 38 through the selection of a coordinate representing a geographic location. The selection process is enabled by the interface 28 generated by the system 10 and accessible through the internet, mobile communication network or other remotely accessible network. A user 38 utilizing an internet access or mobile communication device such as a smart phone 32, laptop 34, desktop computer 36 or any other device capable of accessing a Global Information System (GIS) locations and addresses will access the user interface 28 as indicated at 46. The user interface 28 may be an application executed over an internet connection or an application downloaded and operated on the internet access or mobile phone 32. Moreover, other methods, applications and programs that provide for communication over the internet could also be utilized and are within the contemplation of this disclosure.

A user may also access an organization interface/portal 45 through a web site or application provided through the system 10 maintained by an organization. The system 10 would provide a link that would direct the user 38 to the specific organization example portal. The difference between this mode of accessing the website through an organization maintained interface/portal 45 is that that organization is automatically or preselected 55 for a user 38. During the process 60 recording the coordinates 70 as associated to an organization.

A user 38 will sign up as indicated at 48 through the interface 28 by providing information to generate a user profile 66. The user profile 66 gathers contact information and other information about the user 28 and is stored by the system 10.

Referring to FIG. 3 with continued reference to FIGS. 1 and 2, an example sign up page 84 is shown that includes spaces 86 for user information. The sign up page may also show a graphic of some element or item of interest. In this example, the graphic representation includes representative pictures of general locations other users have selected. The example graphic is of the United States and of the many users 38 that have selected and associated places with pictures.

Users accessing the mobile application can use their mobile or tablet device to take or upload a photo and plot the location based on their immediate proximity. The platform employs standard personal and global privacy practices and allows for various user interaction and social experiences. Moreover, the user interface 28 provides notification when an inch is purchased near the users selected inch, global mapped view of others who support the user selected NPO(s), an, opportunity to comment and rate others photos, stories and the NPOs, the ability to request to connect with users of like cause, geographic or personal interests, and the ability to change inch selection as life interests and experiences change.

Referring to FIG. 4 with continued reference to FIGS. 1 and 2, once a user profile 66 is established, the user 38 will select a coordinate 52 representing a location on the earth by accessing a map as indicated at 50. FIG. 4 is an example coordinate selection page 88 that provides for the selection of the desired coordinates by the user 38. The user 38 may select a geographic location by using an address 68, a known latitude and longitude 70, landmark or by selecting a location on a map as indicated at 72.

The user can employ various search methods to select an inch: address, lat/long, monument/tourist location. They can explore-zoom and click on the map or mobile device. Participating organizations can be searched by name, topic/interest or by clicking Show me local NPOs. The profile page of each owner has a direct link to their designated NPO. They can select as many inches and NPOs/causes as they like and give as much or as often as they like.

FIG. 4 includes a map 92 that maybe zoomed to highlight a desired location for selection by a user. In this example, Yellow Stone National Park is shown and an inch within the National Park may be selected. As appreciated, the map 92 can be moved to reveal any location on the earth and magnified to allow selection of a desired location.

Moreover, a user may also select a location within a predefined area identified as a GeoPreserve® 74 as is indicated at 90. The predefined areas can be popular areas, or areas that are already associated with organizations to allow the user to select a location based on the charitable interests. In this example, the GeoPreserve is Yellowstone National Park. A GeoPreserve® 90 can be locations throughout the world that are of high interest and maintained or preserved by nonprofit or for-profit organizations. The related location coordinates can be pre-purchased by the associated organization in which case the charity is pre-designated. GeoPreserve® locations are also registered in the International Geo Registry™. Examples of a possible GeoPreserve® include Ground Zero Memorial, Vietnam War Memorial, Mt. Rushmore, Eiffel Tower, national parks, religious establishments, Third World Aid locations, NFL & college football stadiums and campuses, etc.

Accordingly, the example coordinate selection portion of the interface 28 provides several options for selecting a desired geographic location.

Once a location is selected, the user is provided with a space to store user content as indicated at 54. User content can include pictures as is best shown in FIG. 3, stories, comments or sentiments reflecting a user's relation to the selected area. The user content provides a means of linking and providing the opportunity for like-minded users to interact and share common experiences.

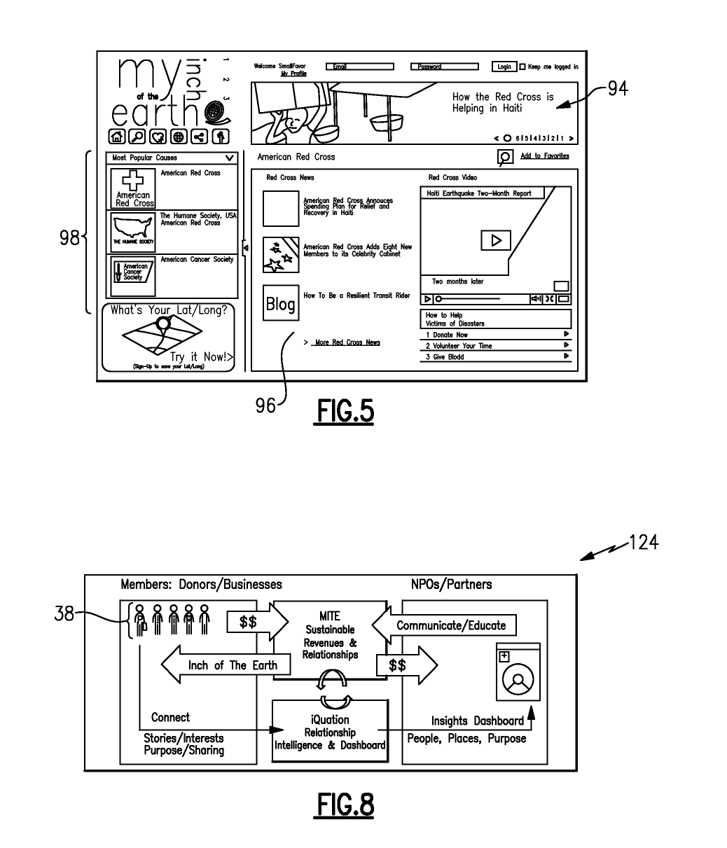

Referring to FIG. 5, with continued reference to FIGS. 1 and 2, once the coordinate representing the desired geographic location is selected 52, an organization is selected as indicated at 56. The organization can be a NPO 26 as is described and shown in this example, and also may be other organizations that have an interest in linking users to a common location. For example, users may select a national park, or other organization for linking to the specific location.

The example page 94 illustrated as FIG. 5 discloses a preview area 98 where several organizations are listed and provides information viewable by a user to aid in selection of an organization. In this example several NPOs are listed including the American Red Cross, The Human Society, and the American Cancer Society. Provided in the main screen area 96 is a description and pictures of content provided by the specific NPO. By selecting an organization in the preview area 98 additional organization details can be viewed in main screen area 96. The information in the main screen area 96 can be provided and maintained by the organization.

In this example, pictures and videos are provided to inform the user of the issues that are benefited by a specific NPO. The NPO can provide updated content through an organization interface 24. The organization interface 24 provides the portal for the organization to inform and update users of events and actions championed by the specific NPO.

Users that enter the site through the organization portal as indicated at 45 have preselected an organization as indicated at 55 and therefore the information provided in the preview area 98 and the main screen area 96 are from the preselected organization.

The selection of an NPO by the user is significant as it prompts the system 10 to direct a transaction server 20 to allocate a portion of the fee 42 paid by the user to that NPO. The NPO gains by the contribution and the user gains by providing an easy way of donating to a cause in concert with linking to other like-minded individuals and exclusive ownership of their selected latitude/longitude 70.

Once the user has selected an organization such as an NPO or other organization, the user is prompted to purchase the coordinate as is indicated at 58. Purchase of the coordinate is accomplished through the transaction server 20. As appreciated, many methods of securing payment over the network are currently in operation and are all within the contemplation of this disclosure. Moreover, more conventional means such as securing a check or other forms of payment to a physical address could also be utilized and are within the contemplation of this disclosure.

The financial transaction is a donation to the specified organization and also a fee for lease of the coordinate representing the selected geographic location. The fee is not a purchase of physical location, but is instead a fee to secure registry of virtual ownership of the selected coordinate for a defined time.

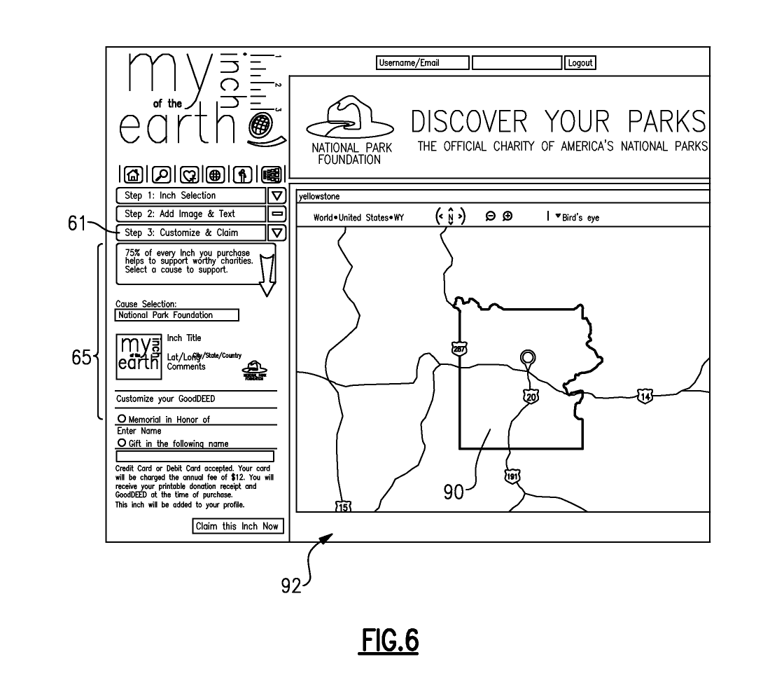

Referring to FIG. 6, with continued reference to FIGS. 1 and 2, the selected coordinate is associated with the user 38 and the selected organization and recorded in the registry as indicated at 60. In this example recording of coordinates 60 is provided in the registry 16 as indicated by the method step 80.

The example page includes graphics representing the steps in the process of signing up and securing the temporary ownership of an inch of the earth. In this example, step 3 indicated at 61 provides for the completion of a certificate by supplying information about the user and what the user wishes to have stated on the certificate as provided by the choices provided as shown at 65.

Referring to step 62 recording of the user association with specific location is commemorated by the issuance of a certificate. In this disclosed example, each coordinate representing a selected inch purchased is authenticated and rewarded with a personalized, printable certificate. In this example the certificate is referred to as a “GoodDEED™” as is indicated at 82 for the selected Lat/Long 70. All Lat/Longs selected by a user 38 are registered in the registry database 16 as a centralized record of latitude and longitude coordinates and deeds.

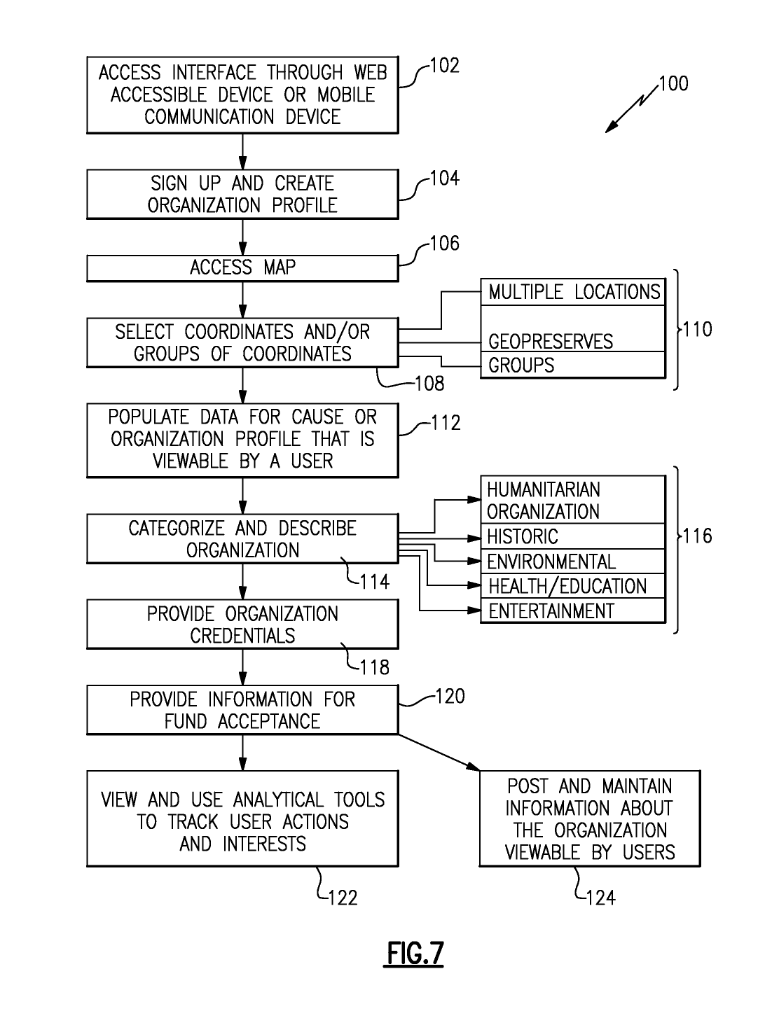

Referring to FIG. 7 and continued reference to FIG. 1, an organization accesses the site through the organization interface 24 (Shown in FIG. 1) and signs up to enable users to contribute to that organization. An organization sign up process is generally indicated at 100 and begins with access to the site as indicated at 102. As appreciated, although several methods are described and disclosed for accessing the example site, it is within the contemplation of this disclosure that a user 38 or organization 26 may access the site through any known method using any known device or communication network.

The organization will sign up and create an organization profile as indicated at 104. The organization profile provides administrative and contact information as is commonly required. Moreover, the profile 104 may provide additional information about the organization that would be of interest to a user and that would further enable a user to evaluate and make an informed selection of that organization.

Once the organization has provided a profile 104, the organization may access a map 106 and select specific coordinates as indicated at 108. Note that an organization need not select any coordinate as a user would provide the selection of a coordinate and than select an organization that may not be associated with a specific location. That is, selection of an organization by a user is not limited by any selection that an organization may make. However, an organization may select coordinates that link to their cause such that a user selection of that coordinates also acts as a selection of that cause.

Moreover, the organization may set up specific areas that provide for the automatic allocation of that organization. The selected areas can include groups or areas of locations, or define a GeoPreserve 90 as indicated at 110 and submitted for approval with the organization credentials 118.

Once geographic areas are selected, the organization is prompted and enabled to populate data that is viewable to a user 112. This selection provides the organization with the opportunity to present promotional materials to interest a user in a cause and to maintain that information to continually update the user.

The organization is prompted to provide a description of itself at step 114 to define and categorize the organization. An organization may categorize itself according to predefined classes as indicated at 116 including humanitarian, historic, environmental, health/education, and athletics. Note that the included examples are not exhaustive and other categories are also within the contemplation of this disclosure.

The organization will then be prompted to provide credentials as indicated at 118 that validate their status. For example a NPO would provide information indicating its approved status with the respective governing body as a not for profit or authorized organization. Moreover, whatever information and validating information may be required to enable preferential or desired financial treatment is provided and utilized by the system.

In completion of the administrative required information; account information is provided as indicated at 120 to enable the transfer of funds. As appreciated, an organization benefits by the continual stream of portions of annuities paid by users. The account information is provided to enable the transfer of a portion of the fees.

With the initial set up complete, the organization continues interaction with the system 10, by maintaining and updating information to communicate with users as is indicated at 124. The organization is provided with access to a portion of the site where they may post pictures, updates, links or any other materials that may be desired to communicate and maintain the interest of users.

The organization is also provided with analytical tools as indicated at 122 that enable tracking and gathering of information relating to user interest, feedback and reaction to the organization. Moreover, the analytical tools can provide an overview and valuable data that can be utilized to improve the organizations presentations and fee collection.

Referring to FIG. 8, a disclosed example organization analytical tool 124 is schematically shown and referred to as iQuation™. The example organization interface provides powerful, yet user-friendly, algorithms that aggregate and provide high-value analytic data and access to tools for partner NPOs and sponsors that enable them to more clearly understand their donor/fan base and develop more relevant communication. Such tools help create sustainable annuity revenues; increases brand awareness, transaction transparency, educational opportunities and custom donor/fan insights. Example data can include separate or aggregate information on user locations and interests that selected the specific organization that allow the organization to better tailor and target an interested audience. Moreover, other information can be provided and tailored to each organization to enable an analysis of user interest, financial commitment and any other data that could be utilized to further adapt and improve contributions and cause awareness.

The example system 10 provides a tool for increasing revenue retention per transaction for NPOs. The system 10 also provides an engaging platform for getting and giving, gaining the interest of an entirely new segment of would be donors. Moreover, the disclosed system creatively addresses the unmet need of finding innovative ways for organizations dependent on donations to inspire new sources of support, replacing the reluctant give requirement with a much more interesting give-and-get experience.

Each participating NPO can have a branded web and mobile portal page and may be required to provide annual reports and links to mission-centric updates. Organizations can also educate donors to its cause through informational banners on each user/donor page. NPOs will choose their listing category and user search words 114. Built-in analytics will help NPOs better understand its donor base and aid in producing more relevant communication.

Unlike giving donors a logo-branded cup or key chain, MITE provides an interactive tool that returns value and recognition to the donor/fan and an ongoing communication channel for a relationship between the donor, NPO and social networks.

Moreover, business owners that also contribute to a NPO can be highlighted and linked with users that also contribute to the same NPO. The user can be alerted to businesses in their local area to create a virtual link to businesses with common interests. The business may also be provided the opportunity of offering incentives to users of a common interest associated with either common NPO or proximate the same coordinates.

NPOs spend countless and valuable employee and volunteer resources coordinating fundraisers. In many cases, taking into account the value of the actual cost of volunteers' time would reveal a deficit. These fundraising methods direct valuable time and resources away from the core mission but are perceived as a necessity for existence.

Other traditional funding sources are becoming more difficult and more restrictive. Government regulations are increasing requirements and decreasing support. Funding organizations and donors have an increased expectation that nonprofits must operate with efficient business practices and no longer provide just “feel good” services. Donors want more transparency and the assurance that their charitable dollars are being used wisely by credible agencies with a mission that serves an identified community need.

There is obviously a large population that gives and undoubtedly a larger population of people who are predisposed to give, but don't, for various reasons: the suggested donation is too high, giving too little feels awkward or embarrassing, not sure who to give to, uncertainty about actual fund usage, anxiety about starting the relationship and being continually pursued for more, concerned about giving and never hearing from the organization again. The reality is most people want to give. NPOs need to reach donors and gain insight into why they give, and affirm that its organization's mission is in line with the wishes of its donors, the need of the communities it serves, and offer transparency of funding initiatives.

The large national and International nonprofits and fan based organizations are already in contact with millions of current donors/fans. These organizations are seeking a reason to reach out to existing donors and offer a unique and engaging micro-donation experience that will encourage them to share it with others to grow their donor base and gain insight into their donor/fan interests. Moreover, the disclosed system and method provides organizations the ability to create a GeoPreserve and designate a group of virtual coordinates associated to at least one charitable organization and use this area as a fundraising platform while gaining user insights and feedback.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of linking users to one or more organizations comprising the steps of:
generating a user interface accessible by at least one of an internet access device and a mobile communication device enabling a selection of a coordinate representing a geographic location by a user;
recording the selection of the coordinate representing a geographic location by the user in a registry;
associating the coordinate selected by the user with one or more organizations selected by the user; and
collecting a fee from the user for maintaining the association between the user and the selected coordinate for a defined time period in the registry.

2. The method as recited in claim 1, wherein the coordinate representing a geographic location comprises a latitude and longitude.

3. The method as recited in claim 1, including designating a portion of the collected fee to the organization selected by the user.

4. The method as recited in claim 1, wherein at least one of the organizations selectable by the user includes a charitable organization and the method comprises designating a portion of the collected fee for payment to the charitable organization.

5. The method as recited in claim 1, including providing a storage location associated with the user and the selected coordinate in which the user may store information.

6. The method as recited in claim 5, including linking at least one of the user, the selected coordinate, and the selected organization with at least one of other users and organizations based on one of the selected coordinate, and the selected organization.

7. The method as recited in claim 1, wherein the selection of a coordinate representing a geographic location is linked to selection of an organization such that selection of coordinate representing a geographic location also enables automatic selection of an organization associated with the selected coordinate representing the geographic location.

8. The method as recited in claim 1, including a grouping of coordinates defining a geo-preserve representing a region and associating the geo-preserve with an organization.

9. The method as recited in claim 1, wherein selection of the coordinate representing a geographic location is performed utilizing positioning determining functions of a mobile communication device.

10. A computer system for linking users to one or more organizations comprising:
at least one computer processor and one computer memory;
an application executed by the at least one computer processor for generating a user interface accessible by an internet access device for enabling a selection of a coordinate representing a geographic location by a user;
a registry stored on at least one computer memory for recording the selection of the coordinate representing a geographic location by the user;
a server associating the coordinate selected by the user with one or more organizations selected by the user and storing the association between the user and the selected organization in a database; and
a transaction server for collecting a fee from the user for maintaining the association between the user and the selected coordinate for a defined time period in the registry.

11. The computer system as recited in claim 10, wherein the application for enabling a selection of a coordinate representing a geographic location comprises a representation of the earth and selectable coordinates specified by a latitude and longitude.

12. The computer system as recited in claim 10, wherein the transaction server includes computer executable instructions for designating a portion of the collected fee to the organization selected by the user.

13. The computer system as recited in claim 10, wherein at least one of the organizations selectable by the user includes a charitable organization and the transaction server includes computer executable instructions for sending a portion of the collected fee to the charitable organization.

14. The computer system as recited in claim 10, including a user accessible memory location for storing information generated by the user that is associated with at least one of the user and the selected coordinate.

15. The computer system as recited in claim 14, wherein the server generates a link between at least one of the user, the selected coordinate, and the selected organization with at least one of other users and organizations based on one of the selected coordinate, and the selected organization.

16. A geographic registry for recording coordinates representing a geographic location selected by a user, the geographic registry comprising:
at least one computer processor and one computer memory;
an application executed by the at least one computer processor for generating an interface accessible by an internet access device; the interface providing for the selection of a coordinate representing a geographic location by a user; and
a database within the computer memory storing the user selected coordinates representing a geographic location and information associating the user with the selected coordinates.

17. The registry as recited in claim 16, wherein the interface provides for selection of a plurality of organizations by the user for association with the selected coordinate and the user.

18. The registry as recited in claim 17, wherein the plurality of organizations comprises a plurality of non-profit organizations.

19. The registry as recited in claim 16, including a mobile access interface utilizing functions present on a mobile communication device for at least selecting a coordinate representing a geographic location based on an immediate location of the user and the mobile communication device.

20. The computer system as recited in claim 15, including a user accessible database residing in the computer memory containing links between organizations.

21. A method of linking users to one or more organizations comprising the steps of:
generating a user interface accessible by at least one of an internet access device and a mobile communication device enabling a selection of a coordinate representing a geographic location by a user, wherein the user does not own the geographic location;
recording the selection of the coordinate representing a geographic location by the user in a registry;
associating the user with one or more organizations selected by the user; and
collecting a fee from the user for maintaining the association between the user, the selected coordinate, and the organization for a defined time period.

22. The method as recited in claim 21, wherein the coordinate representing a geographic location comprises a latitude and longitude and is not an ownership interest in the geographic location represented by the coordinate.

23. The method as recited in claim 21, wherein the association does not comprise a transaction involving the transfer of an ownership interest in the geographic location represented by the selected coordinates.

24. The method as recited in claim 21, wherein the association comprises a charitable organization with no ownership interest in the underlying geographic location represented by the selected coordinates.

25. A computer system for linking users to one or more organizations comprising:
at least one computer processor and one computer memory;
an application executed by the at least one computer processor for generating a user interface accessible by an internet access device for enabling a selection of a coordinate representing a geographic location by a user;
a registry stored on at least one computer memory for recording the selection of the coordinate representing a geographic location by the user;
a server associating the coordinate selected by the user with one or more organizations selected by the user and storing the association between the user and the selected organization in a database; and
a transaction server for collecting a fee from the user for maintaining the association between the user, the selected coordinate and the selected organization for a defined time period.
